(19) United States
(12) Patent Application Publication
(10) Pub. No.: US 2020/0161864 A1
(43) Pub. Date: May 21, 2020

(54) ENERGY MANAGEMENT USING ELECTRONIC FLYWHEEL

(71) Applicant: Energy Harbors Corporation, Inc., Saratoga, CA (US)

(72) Inventors: Shankar Ramamurthy, Saratoga, CA (US); Suhas Badve, Monte Sereno, CA (US)

(21) Appl. No.: 16/747,808

(22) Filed: Jan. 21, 2020

Related U.S. Application Data
(63) Continuation-in-part of application No. 16/378,243, filed on Apr. 8, 2019.
Application No. 16/378,243 is a continuation-in-part of application No. 16/118,886, filed on Aug. 31, 2018.
(60) Provisional application No. 62/795,140, filed on Jan. 22, 2019.
(60) Provisional application No. 62/795,133, filed on Jan. 22, 2019.
(60) Provisional application No. 62/838,992, filed on Apr. 26, 2019.
(60) Provisional application No. 62/916,449, filed on Oct. 17, 2019.
(60) Provisional application No. 62/654,718, filed on Apr. 9, 2018.
(60) Provisional application No. 62/645,859, filed on Mar. 21, 2018.
(60) Provisional application No. 62/679,051, filed on Jun. 1, 2018.
(60) Provisional application No. 62/795,140, filed on Jan. 22, 2019.
(60) Provisional application No. 62/784,582, filed on Dec. 24, 2018.
(60) Provisional application No. 62/795,133, filed on Jan. 22, 2019.
(60) Provisional application No. 62/552,747, filed on Aug. 31, 2017.
(60) Provisional application No. 62/654,718, filed on Apr. 9, 2018.
(60) Provisional application No. 62/654,859, filed on Apr. 9, 2018.
(60) Provisional application No. 62/679,051, filed on Jun. 1, 2018.

(51) Int. Cl. H02J 3/30; H02J 3/38; H02J 7/00; F03C 1/26; F03B 13/00; H02J 3/32; H02J 7/34

(52) U.S. Cl. CPC H02J 3/30; H02J 3/381; H02J 7/0013; H02J 7/345; F03B 13/00; H02J 3/32; F03C 1/26

(57) ABSTRACT

Disclosed techniques include energy management using an electronic flywheel. A plurality of AC electrical power sources is obtained, where the sources are both parallel to and independent from each other. At least one of the plurality of AC sources comprises a motor-generator. The plurality of AC sources is coupled to an AC power grid using an electronic flywheel module, where the electronic flywheel module enables both energy sourcing and energy sinking into a DC energy storage subsystem. Frequencies of the plurality of AC power sources are synchronized using the electronic flywheel module, where the synchronizing is based on an operating frequency of the AC power grid. A mix of energy flow between the plurality of AC sources and the DC energy storage subsystem is regulated. AC power is provided to the AC power grid, where the AC power is conditioned through the synchronizing and the regulating.

### RELATED APPLICATIONS

This application claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

This application is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy management and more particularly to power management using an electronic flywheel.

### BACKGROUND

Worldwide demand for energy is presently increasing at an ever-accelerating rate. While some countries struggle to reduce energy demands and to revamp their energy infrastructures, others are constructing fossil fuel burning power plants, hydro dams, and other traditional or controversial generation sources. This increasing demand is driven by the growth of municipalities, counties, states, and countries, and the development of rural or underserved areas. The demand is further based on increased use of personal electronic devices and household appliances, and improved standards of living. The increases in the living standards, particularly in rural areas, has demanded both the installation of electrical and communications infrastructure and the expansion of transportation networks. Growing populations increase energy demands as more people consume energy for cooking, bathing, cleaning, laundry, and entertaining. Energy is also consumed for illuminating, heating, and cooling houses or apartments. Additional increases in energy demand directly result from expanded economic activities including retail, public transportation, and manufacturing, among many others.

Energy producers, government agencies, and thrifty or responsible energy consumers endeavor to initiate, practice, and enforce energy conservation measures. Consumers can moderate their energy footprints by turning off lights when leaving a room, lowering the thermostat in winter or increasing the thermostat in summer, or purchasing energy-efficient appliances. Each of these simple tasks is a popular approach to reducing cost through energy conservation. While concerted conservation efforts can help, the demand for energy of all types continues to increase beyond savings attributable to conservation alone. The growth of towns, cities, states, and countries increases the demand for energy of all kinds, resulting in what many analysts identify as an energy crisis. Increasing energy demand has many root causes. Increased demand and overconsumption of energy has imposed strains on natural resources ranging from fossil fuels to renewables such as wood chips, resulting in fuel shortages and increased environmental destruction and pollution.

The distribution of energy from generation sources to loads is frequently identified as a hindrance to solving the energy crisis. Existing energy distribution infrastructure is inadequate to meet demand, and aging energy generation equipment is unable to keep pace with the increased energy demands. Renewable energy options remain largely unexplored or underdeveloped. Further, there is strong and vociferous resistance by adjacent landowners and others to siting of mountain or offshore windmills, solar farms, or wood burning plants. Even when plans can be made and permits obtained to construct such energy producing facilities, energy distribution is stymied by the poor distribution infrastructure and the reluctance of landowners to allow high tension lines to traverse their property, particularly when the power is destined for consumers “from away”. Commissioning of new energy generation facilities remains a seemingly unobtainable objective. Legal wrangling, construction delays, pollution mitigation requirements, overwhelming costs, or even war, have prevented, halted, or delayed new energy generation facilities from coming online. Energy loss and wastage remain major concerns. Aging appliances or manufacturing equipment, incandescent light bulbs, and poor building insulation and air sealing, all waste energy in comparison to their modern counterparts.

To meet the many increases in energy demands, public officials at national, state, and local levels, plus city and regional planners, have been faced with deciding among three broad solutions: to increase energy production by building new power plants, to reduce energy demand through energy conservation, or to implement a prudent combination of both these strategies. Another emerging option is to source energy production based on renewable energy sources such as solar, wind, biofuels, geothermal, wave action, and so on. The primary limitation of many renewable energy sources is that the sources do not produce consistent amounts of energy all day, every day. Solar energy only produces energy in the presence of light, and produces varying amounts of energy depending on the intensity of the light hitting photovoltaic panels. Wind energy only produces energy when the wind is blowing. Energy sources and demands must be balanced so that clean, reliable, and consistent energy is available at all times to all consumers throughout the country.

### SUMMARY

Energy can be produced by diverse and disparate generation sources, where the generation sources can be local or far-flung, based on fossil fuels or renewable energy sources, and so on. The difference between energy production and energy consumption typically increases or decreases over a given period of time. These differences can further depend on a timeframe such as day versus night, day of the week, manufacturing schedules, seasonal factors such as heating or cooling, and so on. The discrepancies between energy production and consumption can be significant and at times critical. The discrepancies can be correlated to time-dependent energy demands, changeable energy production capabilities such as the presence or absence of a renewable resource used to generate the energy, available capacity of commercial or grid power, the amount of standby or backup energy, turning on or turning off electrical equipment, and so on. To ameliorate the energy production/consumption asymmetry, energy that is in excess to demand at a given time can be stored or sunk for later use. The stored energy can be retrieved or sourced when demand exceeds a given power level. Energy can be collected and stored when a renewable resource is available, when the energy available exceeds the energy needed, or even when the cost of production of the energy is relatively inexpensive. The stored energy can be used to augment available energy or instead to provide the amount of energy that is needed during periods of increased or unmet energy need. The recovery of stored energy can be applied to low-level energy demand scenarios, such as the energy needs of a house or small farm operation, or to larger scale energy needs such as the energy needs for manufacturing, or even to the largest energy needs such as an energy distribution grid.

Disclosed techniques address energy management using an electronic flywheel. A plurality of AC electrical power sources is obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, where the AC power is conditioned through the synchronizing and the regulating.

A computer-implemented method for energy management is disclosed comprising: obtaining a plurality of AC electrical power sources, wherein the sources are both parallel to and independent from each other; coupling the plurality of AC sources to an AC power grid using an electronic flywheel module, wherein the electronic flywheel module enables both energy sourcing and energy sinking into a DC energy storage subsystem; synchronizing frequencies of one or more of the plurality of AC power sources using the electronic flywheel module, wherein the synchronizing is based on an operating frequency of the AC power grid; regulating a mix of energy flow between the plurality of AC sources and the DC energy storage subsystem; and providing AC power to the AC power grid, wherein the AC power is conditioned through the synchronizing and the regulating. In embodiments, at least one of the plurality of AC sources comprises a motor-generator. In embodiments, the synchronizing includes adjusting the speed of the motor-generator. In embodiments, the motor-generator comprises a pump-turbine. Some embodiments comprise coupling a water piston heat engine using the pump-turbine. In some embodiments, the water piston heat engine is operated by an energy management control system, and the energy management control system controls transfer of energy within the pump-turbine, the water piston heat engine, and the electronic flywheel module.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy management using an electronic flywheel.

FIG. 2 illustrates an electronic flywheel.

FIG. 3 shows electrical interfaces.

FIG. 4A illustrates a large energy management subsystem.

FIG. 4B is an example energy system.

FIG. 5 shows energy storage and recovery.

FIG. 6 illustrates an energy internet block diagram.

FIG. 7 shows a software-defined water piston heat engine (WPHE).

FIG. 8 illustrates fluid-based pump energy input/output.

FIG. 9A is a flow diagram for multi-layered system balancing.

FIG. 9B shows pressure vessel level output waveforms.

FIG. 9C shows multi-layered system balancing waveforms.

FIG. 10 is a system diagram for energy management.

### DETAILED DESCRIPTION

This disclosure provides techniques for energy management using an electronic flywheel. The energy management is based on obtaining AC electrical energy sources and storing energy in a DC energy storage subsystem. The AC electrical energy sources, or power sources, and the DC energy storage subsystem can be a parts of a large-scale energy storage subsystem which can store energy from one or more points of generation. The stored energy can be provided after a period of time to meet energy demands of dynamic loads. The energy that is stored can be received from diverse and disparate energy sources. Energy can be stored when the amount of energy available from the AC energy sources exceeds the energy demand at the time of energy generation. The energy can be stored for a period of time. The energy storage includes electrical energy storage using batteries or capacitors. The energy storage can include fluid or gas storage based on multiple pressurized storage elements such as compressed air storage elements. The energy storage can include the one or more pressure amplification pipes. The storage of the energy and the recovery of the energy can include use of a water piston heat engine (WPHE). Managing the sourcing, storing, and transforming of energy are complex and difficult tasks. Energy management can be influenced by many factors including the weather, wide-ranging energy usage demands, variable pricing schemes, and so on. Energy management can be further complicated by quickly changing customer energy demands, requirements of service level agreements (SLAs), etc. Despite the growing use of renewable energy resources such as solar, wind, wave action, tidal, geothermal, biofuels, biogas, and the like, two significant challenges remain: the amount of energy produced by a given energy source can be highly variable, and the availability of the given energy source may be inconsistent. As an example, wind energy is only available when wind is present, solar energy only when the sun is shining, wave action energy only when there are waves present, and so on.

Energy with intermittent availability or excess energy can be stored or sunk when the energy is being produced, and can be extracted or sourced at a later time when the stored energy is needed. A similar strategy can be used based on price, where energy is stored when production cost is low, then later extracted when the energy production cost is high. The stored energy can be used in combination with other energy sources such as motor-generator power or pump-turbine power to meet energy demands at particular times. Storage can include a period of time, where the period of time can be a short-term basis or a long-term basis. Energy losses are introduced when converting energy from one energy type to another energy type. Further losses occur when storing energy, extracting energy, routing energy, etc. Minimizing the energy losses is critical to any energy storage and sourcing/sinking technique. Electrical energy storage is possible using techniques such as mature storage battery technologies, but the costs of large battery banks are prohibitive in terms of up-front cost and maintenance costs. Further, batteries are problematic for long-term storage purposes because of charge leakage.

In disclosed techniques, energy management uses an electronic flywheel. Excess energy can be stored or sunk for a period of time. The excess energy that was stored can be retrieved or sourced for later use. The energy can be obtained locally from wind turbines, photovoltaic arrays, motor-generators, etc. The energy can be generated using fuels such as coal, natural gas, or nuclear sources; using hydro power or geothermal energy; using renewable sources such as solar, wind, tidal, wave-action, biofuels or biogas; using pump-turbine sources such as compressed air, steam, or ice; or using backup power sources such as diesel-generator sets; and so on. A plurality of AC electrical power sources is obtained, where the sources are both parallel to and independent from each other. At least one of the plurality of AC sources can include a motor-generator such as a diesel-generator (DG) set. The motor-generator can include a pump-turbine. The sources can be part of a larger energy management system that includes energy sources, energy storage subsystems, energy distribution, etc. The energy storage subsystem can store electrical energy, potential energy, thermal energy, kinetic energy, etc. The plurality of AC sources is coupled to an AC power grid using an electronic flywheel module. The electronic flywheel module enables both energy sourcing and energy sinking into a DC energy storage subsystem. The energy storage subsystem can store the DC energy in batteries, capacitors including supercapacitors, etc. Frequencies of one or more of the plurality of AC power sources are synchronized using the electronic flywheel module, where the synchronizing is based on an operating frequency of the AC power grid. The operating frequency of the AC power grid can include 50 Hz, 60 Hz, etc. The synchronizing can include adjusting the speed of the motor-generator. A mix of energy flow is regulated between the plurality of AC sources and the DC energy storage subsystem. The regulating can include sinking excess energy into the DC energy storage subsystem, sourcing needed energy from the DC energy storage subsystem, etc. AC power is provided to the AC power grid, where the AC power is conditioned through the synchronizing and the regulating. The providing can enable surge, startup, or inrush power regulation to the motor-generator. The providing conditions enable power flow within the AC power grid. The conditioning can be used to correct or mitigate electrical faults. The power flow that is conditioned includes mitigation of voltage harmonics, voltage droop, current surge, loss of power, leakage, and phase balance. The AC power grid to which the AC power is provided can include a utility transmission grid, a wide-scale distribution grid, or a local microgrid.

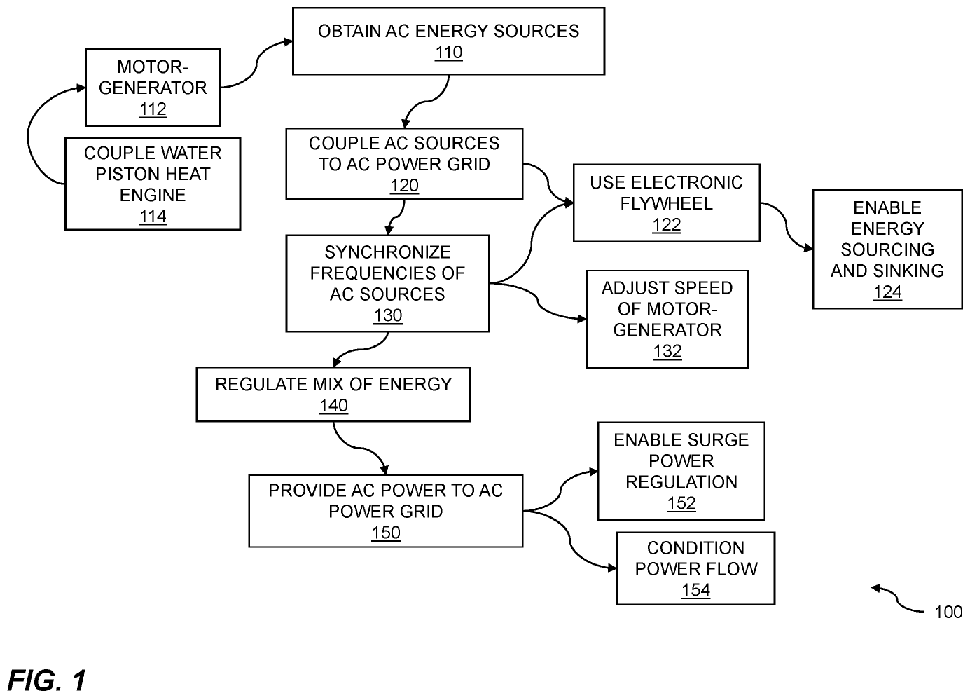

FIG. 1 is a flow diagram for energy management using an electronic flywheel. Energy storage and management can be based on an electronic flywheel module. The electronic flywheel can be used to couple AC energy sources to an AC energy grid. The electronic flywheel further can be used to sink or source energy into a DC energy storage subsystem. Other forms of energy can be sourced or sunk using the electronic flywheel. In embodiments, the electronic flywheel can be used to source or sink fluid energy, gas energy, two-phase liquid-gas energy, and the like. The electronic flywheel module can be part of a large energy storage subsystem, where the energy storage subsystem can include multiple batteries or capacitors such as supercapacitors, pressurized storage elements such as high-pressure water, pressurized air, steam, ice-water slurry, and the like. A plurality of AC electrical power sources is obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. A mix of energy flow is regulated between the plurality of AC sources and the DC energy storage subsystem. AC power is provided to the AC power grid, where the AC power is conditioned through the synchronizing and the regulating.

A flow 100 for energy management using an electronic flywheel is shown. An electronic flywheel can include coupling energy sources to grids and to energy storage subsystems. Energy, such as electrical energy from a traditional electrical grid, energy from renewable sources, and so on, can be stored. Other forms of energy including mechanical energy, pressure, and so on can also be stored. The energy can be transformed into an energy format which can be stored for a length of time. Energy management can be used for storing, retrieving, or extracting energy from an energy storage subsystem such as a DC energy storage subsystem. The energy storage subsystem can be a large-scale energy storage subsystem or can be a small-scale energy storage subsystem. The energy storage subsystems can be based on battery storage, capacitor storage, inductive storage, compressed air storage, steam or ice storage, ice-water slurry, and so on. The energy storage subsystem can receive or sink energy from an AC source such as a pump-turbine storage subsystem. A pump-turbine storage subsystem can include energy storage or retrieval elements such as high-pressure chambers, compression-expansion chambers, compressed air chambers, and so on. A pump-turbine energy management system can be implemented within a non-productive oil well infrastructure, unused salt caverns, aquifers, large cavities underground, or porous rock structures capable of holding air or water under pressure. The energy storage subsystems can include a DC energy storage subsystem. The storage elements of an energy storage subsystem can store various energy types including electrical energy, thermal energy, kinetic energy, mechanical energy, hydraulic energy, and so on.

The flow 100 includes obtaining a plurality of AC electrical power sources 110, where the sources are both parallel to and independent from each other. The AC electrical power sources can include a wide range of energy sources. The AC electrical power sources can include renewable energy sources such as solar, wind, geothermal, tidal, or wave action sources. In embodiments, at least one of the plurality of AC sources can include a motor-generator 112. Motor-generator AC electrical energy sources can be used to generate AC power, to correct electrical problems with an AC electrical energy source such as a grid energy source, etc. The motor-generator can be coupled to other energy storage and retrieval subsystems. In embodiments, the motor-generator can include a pump-turbine. The pump-turbine can be driven by electrical energy applied to the pump, by a gas or a liquid used to spin the turbine, and so on. The pump-turbine can be used to obtain or couple other energy subsystems. Further embodiments include coupling a water piston heat engine 114 using the pump-turbine. The water piston heat engine (WPHE) can be used to store two-phase energy such as gas-liquid energy, gas energy, and the like. In embodiments, the water piston heat engine can enable fluid energy storage. The fluid energy storage can include high pressure or low pressure storage using one or more pressure amplifier pipes. The WPHE can be operated such that the WPHE can operate at an optimum pressure point. To operate at the optimum pressure point, in embodiments, the water piston heat engine can be operated by an energy management control system. The energy management control system can obtain energy sources, couple energy sources, and so on. In embodiments, the energy management control system can control transfer of energy within the pump-turbine, the water piston heat engine, and the electronic flywheel module.

The flow 100 includes coupling the plurality of AC sources to an AC power grid 120. The coupling can include coupling the AC sources to more than one AC power grid. The AC power grid can include a grid onsite of a farm or factory, or within a neighborhood; a city-wide grid; a state-wide or region-wide grid; a national grid, and so on. In embodiments, the AC power grid can include a utility transmission grid, a wide-scale distribution grid, or a local microgrid. The coupling the AC sources to the AC power grid includes using an electronic flywheel module 122. As discussed throughout, the electronic flywheel module can be used for stabilizing AC power, correcting electrical issues with the AC power, and so on. In embodiments, the electronic flywheel module enables both energy sourcing and energy sinking 124 into a DC energy storage subsystem.

The energy sources can at times produce an amount of energy in excess of the amount of energy needed by various loads. Excess energy can be produced by turbines on a windy day, photovoltaic panels on a bright, sunny day, and so on. At such times, excess energy can be stored or “sunk” into the DC energy storage subsystem. When an excess of energy is available, the DC energy storage system sinks excess energy from the plurality of AC sources through the electronic flywheel module. The DC energy can be stored using a variety of storage techniques. In embodiments, the DC energy storage subsystem includes batteries and capacitors. Batteries of the DC energy storage subsystem can include sealed lead acid (SLA) batteries, lithium-ion batteries, nickel-metal hydride batteries, lithium-iron-phosphate (LiFePO4) batteries, etc. In embodiments, the excess energy can be used to charge the batteries of the DC energy storage system. The batteries used by the DC energy storage subsystem can be chosen based on leakage, size, weight, cost, maintenance requirements, and the like. In other embodiments, the excess energy can be used to charge the capacitors of the DC energy storage system. Various types of capacitors can be used. In other embodiments, the capacitors include supercapacitors. At other times, the energy sources can produce an amount of energy less than the amount of energy needed by the various energy loads. At such times, the energy shortfall can be met by sourcing energy stored in the DC energy storage subsystem. In embodiments, the DC energy storage subsystem can source stored energy to the AC power grid through the electronic flywheel module. The amount of energy that can be sourced by the DC energy storage subsystem can depend on an amount of stored energy available, an amount of time during which stored energy can be provided, etc. In embodiments, the stored energy can be provided from the batteries or the capacitors of the DC energy storage system.

The flow 100 includes synchronizing frequencies of one or more of the plurality of AC power sources 130 using the electronic flywheel module 122. The synchronizing is based on an operating frequency of the AC power grid. In order to couple an AC source to an AC power grid, not only must the voltages of the source and the grid be equal, so must the frequencies of the AC source and the AC power grid. The operating voltage and the operating frequency of the AC power grid can be based on location of the grid. Typical grid voltages can include 100, 110, of 120 volts, 220 of 240 volts, etc. Typical grid frequencies can include 50 Hz or 60 Hz. In order to prevent damage to the AC power sources and the AC power grid, the correct voltage with the correct frequency can be applied in phase with the AC power grid. Since an AC power source may be out of phase with an AC grid, the phase of the AC power source can be adjusted. In embodiments, the synchronizing can include adjusting the speed of the motor-generator 132. The adjusting can include adjusting frequency, adjusting phase, etc., until the AC source is at the same frequency as and in phase with the AC grid.

The flow 100 includes regulating a mix of energy 140 flow between the plurality of AC sources and the DC energy storage subsystem. The regulating can include selecting which of the plurality of AC sources to couple to the AC power grid, determining an amount of energy to source to or sink from or to the DC energy storage subsystem, etc. The DC energy storage subsystem may have restrictions such as usage restrictions regarding the subsystem. The usage restrictions can include an amount of energy that can be sunk or sourced, a number of times the batteries or capacitors can be charged or discharged, a level or an average level of charge or discharge such as a percentage charged or discharged, an age of a battery or a capacitor, etc. The flow 100 includes providing AC power to the AC power grid 150, where the AC power is conditioned through the synchronizing and the regulating. The providing AC power to the AC grid can include providing energy from one or more of the plurality of AC electrical energy sources, sourcing energy from the DC energy storage subsystem, and so on. The amount of AC power that is provided can be time-dependent, such as providing an increased amount of power when starting a motor, a motor-generator, a pump-turbine, etc. In embodiments, the providing can enable surge power (inrush current) regulation 152 to the motor-generator. The providing further can be based on conditioning the AC power that is provided to the AC power grid. The AC power that is provided can experience various electrical faults. In embodiments, the providing can condition power flow 154 within the AC power grid. The conditioning can include correcting over-voltages or under-voltages, frequency errors, phase errors, and the like. In embodiments, the power flow that is conditioned can include mitigation of voltage harmonics, voltage droop, current surge, loss of power, leakage, and phase balance. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

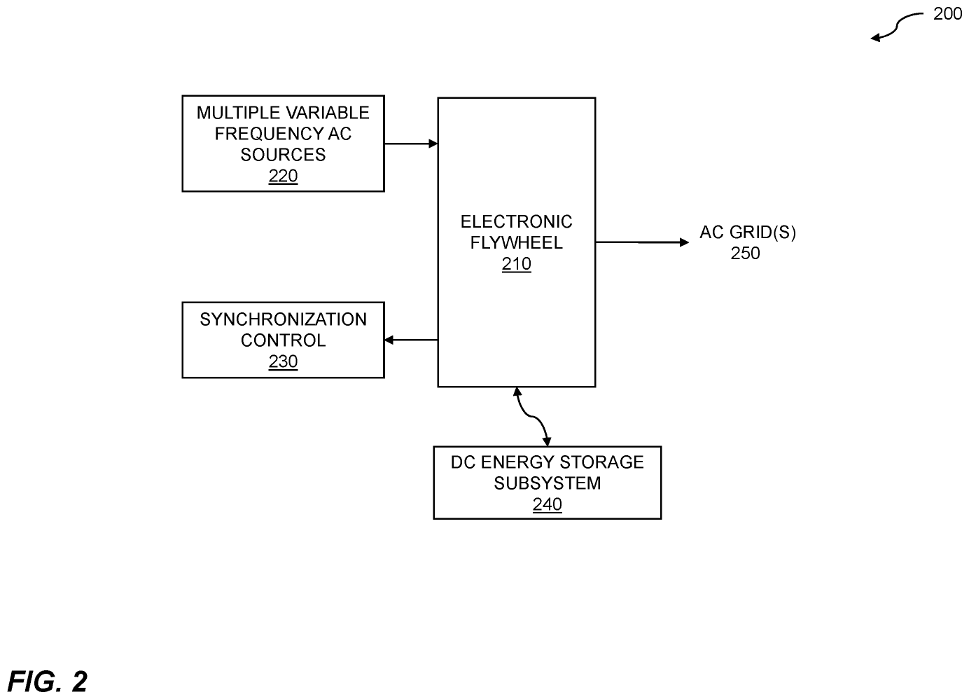

FIG. 2 illustrates an electronic flywheel 200. An electronic flywheel can be used to couple AC energy sources to an AC power grid by synchronizing and regulating the AC sources. The electronic flywheel enables energy management. A plurality of AC electrical power sources is obtained, where the sources are both parallel to and independent from each other. The plurality of AC sources is coupled to an AC power grid using an electronic flywheel module, wherein the electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, where the AC power is conditioned through the synchronizing and the regulating.

Various power sources can be coupled to a power grid. Quintessential difficulties of coupling such diverse power sources to the power grid can include voltage fluctuations or droops, current surges, AC frequency phase shifts, and so on. In order to couple the diverse power sources to the power grid, the power sources must be synchronized with the frequency of the power grid, regulated with respect to voltage or current, etc. In place of a mechanical flywheel coupled to a motor-generator, an electronic flywheel can be used for energy management. The electronic flywheel 210 can be coupled to one or more AC sources 220. The AC sources, as discussed throughout, can vary with respect to operating frequency, availability (e.g. renewable sources), and so on. The AC sources can include grid power from coal or oil, nuclear, or hydro; renewable sources from biofuel, biogas, geothermal, solar, wind, tidal, or wave action; and the like. Some or all of the AC power sources may or may not be available at a given time. Prior to coupling one or more of the AC sources to a grid, the frequencies of the AC sources must be synchronized. The synchronizing of the frequencies of the AC sources can be accomplished by using synchronization control 230. Synchronization control can be used to align or synchronize the AC power sources so that their frequencies are in phase.

An amount of energy available from the multiple variable frequency AC sources may at times exceed load demand, while at other times the amount of energy available will be less than load demand. The electronic flywheel can enable both energy sourcing and energy sinking into a DC energy storage subsystem 240. The DC energy storage subsystem can store the DC energy in batteries, capacitors, and so on. In embodiments, the batteries can include sealed lead acid (SLA) batteries, lithium-ion batteries, nickel-metal hydride batteries, lithium-iron-phosphate (LiFePO4) batteries, etc. In other embodiments, the capacitors can include supercapacitors. The electronic flywheel can provide AC power to an AC grid 250. The AC grid can include a local grid, a regional grid, a national grid, and so on. In embodiments, the AC power grid can include a utility transmission grid, a wide-scale distribution grid, or a local microgrid.

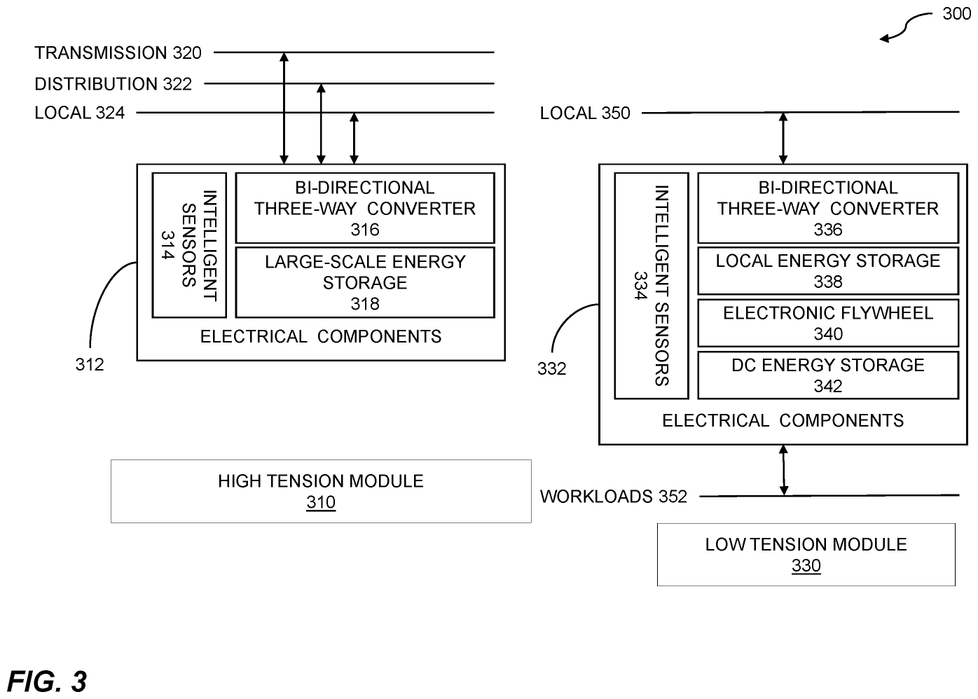

FIG. 3 shows electrical interfaces. An electrical interface can be used to couple together one or more energy sources, one or more energy grids, and so on. The electrical interface can support energy management using an electronic flywheel. AC electrical power sources are obtained, where the sources are both parallel to and independent from each other. The AC sources are coupled to an AC power grid using an electronic flywheel module, where the electronic flywheel module enables both energy sourcing and energy sinking into a DC energy storage subsystem. Frequencies of the AC power sources are synchronized using the electronic flywheel module, where the synchronizing is based on an operating frequency of the AC power grid. A mix of energy flow between the AC sources and the DC energy storage subsystem is regulated. AC power is provided to the AC power grid, where the AC power is conditioned through the synchronizing and the regulating.

An electrical interface is shown 300. The electrical interface can comprise a component or subsystem within an energy management system. The electrical interface can interface one or more energy modules or energy subsystems. The electrical interface can include one or more high tension modules 310. A high tension module can include a 10 megawatt module. The high tension module can include components or subsystems for managing high tension energy. In embodiments, the high tension module can include electronic components 312. The electronic components can sense, store, convert, and so on, energy. In embodiments, the electronic components include one or more intelligent sensors 314 for measuring voltage, current, phase, etc.; one or more bi-directional 3-way converters 316 to convert energy from or to various voltages, from AC to DC or DC to AC, etc.; and large-scale energy storage 318. The large-scale energy storage can include electrical energy storage in batteries or capacitors, liquid energy storage, gas energy storage, and the like. The high tension module can obtain AC electrical energy from one or more energy grids. In embodiments, the AC power grid energy grids can include a utility transmission grid 320, a wide-scale distribution grid 322, or a local microgrid 324. The utility transmission grid can include a megavolt (MV) grid, the wide-scale distribution grid can include an 11 kilovolt (kV) to a 66 kV grid, the local grid can include a 220 V to 480 V grid, and so on.

The electrical interface can include one or more low tension modules 330. A low tension module can include 10 kW module. The low tension module can include components or subsystems for managing, controlling, distributing, etc., low tension energy. In embodiments, the low tension module can include electronic components 332. The electronic components can include intelligent sensors 334, bi-directional 3-way converters 336, local energy storage 338, and so on. The low tension module can include one or more electronic flywheels 340, where the electronic flywheels can enable energy sourcing and energy sinking into the local energy storage. In embodiments, the local energy storage can include a DC energy storage subsystem 342. The DC energy storage subsystem can store electrical energy or other forms of energy. Electrical energy storage by the DC energy storage subsystem can be accomplished using one or more batteries, one or more capacitors, and the like. The low tension module can obtain AC electrical energy from one or more local energy grids 350 or microgrids. One or more workloads 352 can be coupled to the low tension module. The workloads can include pump-turbines, motor-generators, or other electrical or electronic equipment.

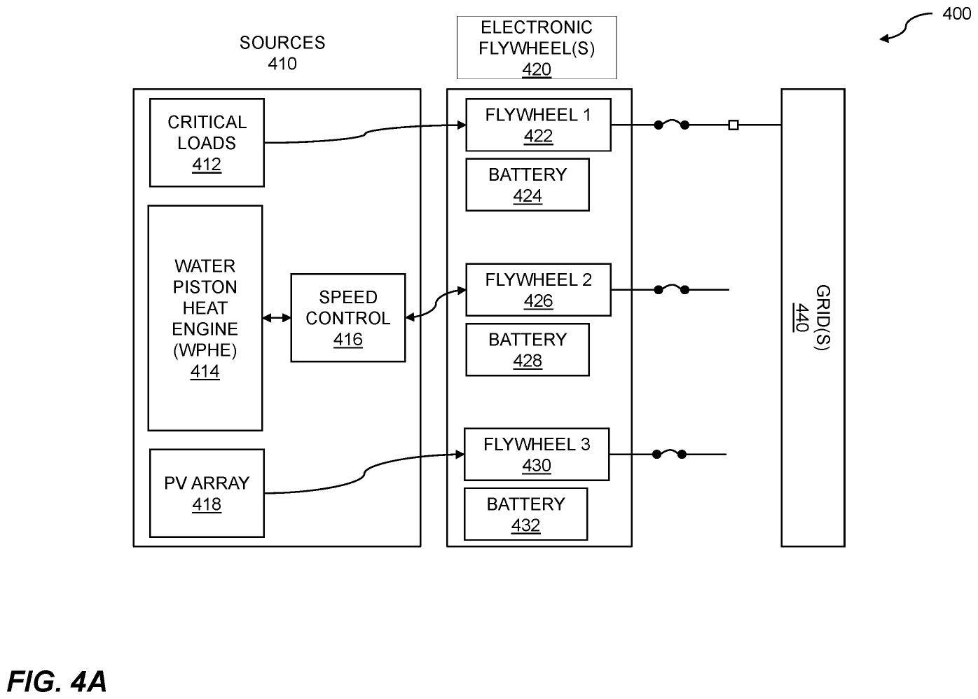

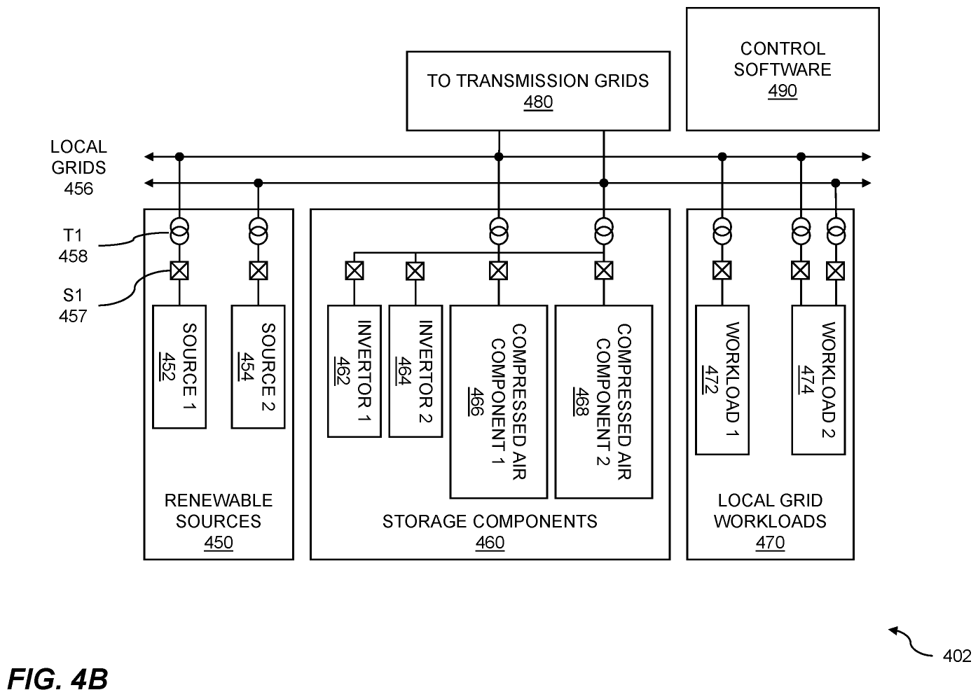

FIG. 4A illustrates a large energy management subsystem. An energy management subsystem can be a component of an energy management system which includes one or more of an energy controller subsystem, an energy source, an energy storage subsystem, an energy load or sink, and so on. The energy management system can be coupled to a plurality of AC sources, a plurality of DC sources, and so on. In embodiments, at least one of the plurality of AC sources can include a motor-generator. A motor generator can be used to counteract one or more problems with energy sources, where the problems can include voltage harmonics, voltage droop, current surge, loss of power, leakage, phase balance, and so on. In embodiments, the motor-generator can include a pump-turbine, where the pump-turbine can be used to pump liquids or gases, two phases such as gas and liquid, etc. The pump-turbine can convert energy stored in a liquid or gas to another form of energy such as electrical energy. A plurality of AC electrical power sources is obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, wherein the AC power is conditioned through the synchronizing and the regulating.

An example 10 kilowatt energy management subsystem is illustrated 400. As discussed throughout, the 10 kW energy management subsystem can be a component or module of an energy system. The energy management subsystem can include one or more sources 410. The energy sources can be coupled to loads, where the loads can include critical loads 412. The critical loads can include energy management subsystem infrastructure such as switches, processors, processor or computer networks, communications subsystems, valve control subsystems, safety subsystems, and the like. The one or more energy sources can include a pump-turbine water piston heat engine (WPHE) subsystem 414. The pump-turbine can include a permanent magnet synchronous motor (PMSM), where the rotational speed (angular velocity) of the PMSM shaft is determined by the frequency of the energy source coupled to the PMSM. The frequency of the energy source may change (e.g. drift). The frequency can change due to a change of energy source, where the second energy source may have a frequency different from that of the first energy source. The angular velocity of the PMSM shaft can be controlled using speed control 416, where the speed control can be based on a variable frequency drive (VFD). The VFD can be used to maintain a constant angular velocity of the PMSM by changing the frequency of the energy source coupled to the PMSM. In embodiments, the VFD can include speed control of 0.5%. The one or more energy sources can include a photovoltaic (PV) array 418. The PV array can generate DC energy, where the amount of DC energy that is obtained from the PV array can be controlled by a maximum power point tracker (MPPT). In embodiments, the MPPT can be coupled to an inverter to convert the DC energy from the MPPT to AC energy.

The 10 kW energy management subsystem can include one or more electronic flywheels 420. Recall that a flywheel, such as a mechanical flywheel, can be coupled to a motor-generator set. The mechanical flywheel can be used to maintain angular velocity thus minimizing variations in angular velocity of the motor-generator set. An electronic flywheel can perform an analogous minimization of angular velocity variation. Rather than storing energy as angular momentum of a spinning flywheel, energy accessible by the electronic flywheel can store energy as steam or compressed gas such as air. Three electronic flywheels are shown, flywheel 1 422 with an associated storage subsystem such as battery 424; flywheel 2 426 with associated battery 428; and flywheel 3 430 with associated battery 432. While three electronic flywheels and associated batteries are shown, other numbers of flywheels can be included. Similarly, other numbers of batteries can be included, such as one battery shared among a plurality of flywheels. The batteries can be coupled in parallel. The batteries can be used to provide energy while one or more electronic flywheels are “spinning up” to provide energy. In embodiments, the capacitors can be used in conjunction with the batteries or in place of the batteries. The one or more electronic flywheels can include one or more switches, one or more energy backup subsystems such as one or more uninterruptable power supplies (UPSs), and so on.

The one or more electronic flywheels can obtain energy using the one or more switches to select from an AC electrical energy source such as a motor-generator, a pump-turbine, a photovoltaic array, etc. The one or more switches further can select energy from a DC energy storage subsystem. The DC energy storage subsystem can be based on batteries such as sealed lead acid (SLA) batteries, lithium-ion batteries, nickel-metal hydride batteries, lithium-iron-phosphate (LiFePO₄) batteries, etc. The DC energy storage subsystem can be based on capacitors. In embodiments, the capacitors can include supercapacitors. The one or more electronic flywheels can be used to synchronize frequencies of one or more of the plurality of AC power sources. The synchronizing can be used to match the frequencies of the one or more sources to a standard frequency, to each other, to a load, etc. In embodiments, the synchronizing can include adjusting the speed of the motor-generator. The 10 kW energy management system can include an AC power grid 440. The AC power that can be provided to the AC power grid can be conditioned. The conditioning of the AC power can be accomplished by the one or more electronic flywheels, where the conditioning can be based on synchronizing frequencies of the one or more AC power sources and by regulating the mix of energy flow between the AC power sources and the DC energy storage subsystem. In embodiments, the power flow that is conditioned can include mitigation of voltage harmonics, voltage droop, current surge, loss of power, leakage, and phase balance. The AC power grid can include a local grid, a regional or state-wide grid, a national grid, and so on. In embodiments, the grid can include a utility transmission grid, a wide-scale distribution grid, or a local microgrid.

FIG. 4B is an example energy system. Discussed throughout, an energy system can include energy sources such as grid power, energy storage components, workloads, and so on. The energy system can further include one or more energy management components. In embodiments, energy management can be accomplished using one or more electronic flywheels. A plurality of AC electrical power sources is obtained, where the sources are both parallel to and independent from each other. The plurality of AC sources is coupled to an AC power grid using an electronic flywheel module. The electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, where the AC power is conditioned through the synchronizing and the regulating. In embodiments, the AC power that is provided to the AC power grid includes three-phase AC power.

The example energy system 402 includes renewable sources 450. The renewable sources can include one or more of photovoltaic panels (PVs), wind turbines, wave action sources, tidal sources, geothermal sources, biomass or biogas sources, and so on. The renewable sources can include source 1 452, source 2 454, and so on. The renewable sources such as 452 and 454 can be coupled to one or more local grids 456. The coupling of a renewable source such as source 1 to the local grid or grids can be enabled by a switch such as S1 457 and a transformer such as T1 458. The example energy system can include storage components 460. The storage elements can store electrical energy, mechanical energy, thermal energy, energy within a compressed gas, and so on. The storage components can include DC storage components such as batteries or capacitors. The DC storage energy elements can provide energy to a microgrid by inverting the DC energy to form AC energy. The inversion of the DC energy to AC energy can be accomplished using invertor 1 462, inverter 2 464, and so on. An inverter can include a grid-tied inverter (GTI). In embodiments, the inverters inverter 1 and inverter 2 can comprise grid-forming inverters. A grid-forming inverter differs from a grid-tied inverter in that a grid-forming inverter can regulate both voltage and frequency. The storage components can further include one or more compressed air components such as compressed air component 1 466, compressed air component 2 468, and so on. A compressed air component can be based on one or more of a pump-turbine, a water reservoir, pressure storage vessels, and the like. The compressed air component can further include a variable-frequency drive (VFD). The VFD can be used to regulate frequency and voltage of an AC signal. The one or more storage elements can be coupled to the one or more local grids through switches and transformers, as discussed previously.

The example energy system can include one or more local grid workloads 470. The local grid workloads can include motors, pumps, HVAC equipment, and so on. Two local workloads are shown, workload 1 472 and workload 2 474. While two workloads are shown, other numbers of workloads can be included. The workloads can be coupled to local grids using switches and transformers, as discussed previously. The one or more workloads can include high availability workloads, lower availability workloads, etc. A high availability workload such as workload 2 can include “dual draw” capabilities and can be coupled to two local grids. A lower availability workload such as workload 1 can be coupled to one or more load grids to provide “single draw”, “dual draw”, and the like. The example energy system can be coupled to one or more transmission grids 480. The transmission grids can be used to transfer energy such as energy previously stored within storage components to municipal or manufacturing grids, state or regional grids, national grids, etc.

The example energy system can be controlled using control software 490. The control software can be used to manage the various components of the energy system such as one or more renewable sources, one or more grid-forming inverters, one or more compressed air components, one or more workloads, one or more local grids, and so on. The control software can manage one or more energy system configurations, where the one or more configurations can be based on a service level agreement (SLA). The control software can be used to switch in or switch out sources, storage components, or loads based on energy requirements, maintenance schedules, equipment failure, load spikes, etc. The control system can enable selection or deselection of renewable sources, storage components, workloads, etc., by enabling or disabling switches such as switch S1. The control software can manage the interface between one or more local grids and one or more transmission grids. In embodiments, the control software can enable an intelligent energy supply configuration of the energy system. The software can be used to manage spikes in power demand. In embodiments, the control software can be used to maintain grid stability by switching off low priority loads during peaks or spikes in power demand, switching out sources or loads based on faults or other conditions, etc.

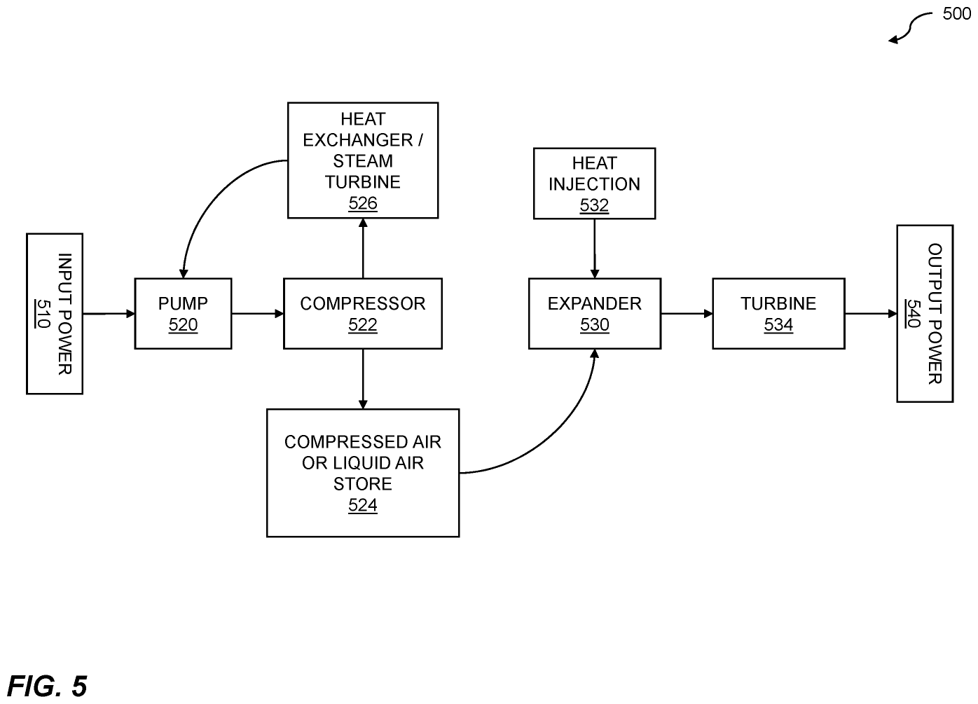

FIG. 5 shows energy storage and recovery 500. Energy management can include storing energy for a period of time where the period of time can include a short-term basis, a long-term basis, and so on. The stored energy can be recovered and delivered to meet one or more energy load requirements. Energy storage and recovery can enable energy management using an electronic flywheel. A plurality of AC electrical power sources can be obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, where the AC power is conditioned through the synchronizing and the regulating.

Input power 510 can include energy sources such as grid energy from sources including coal or natural gas, and nuclear; and renewable energy sources such as solar, hydro, wind, tidal, and wave action. Energy produced from some renewable energy sources can be intermittent. Solar or wind generation relies on the presence of sunlight or wind, respectively. Solar generation is at a minimum on a cloudy day, and substantially zero at night, while wind generation is substantially zero when the wind is calm. Since energy load requirements persist even in the absence of sunlight or wind, for example, energy generated intermittently can be stored. Energy storage can be based on electrical storage, chemical storage, pressure storage, and so on. In embodiments, energy can be stored by using a pump 520. The pump can include an electrically operated pump, a turbine driven pump, and the like. The pump can drive a compressor 522 which can be used to store energy in various forms. In embodiments, the compressor can be used to store energy as compressed air or liquid air. The compressed air or the liquid air can be stored in a store 524. The compressor can also be used to generate steam. In embodiments, the compressor can drive a heat exchanger/steam turbine 526. The steam can be used to spin the turbine, which can be used to operate the pump 520. Energy as excess heat, including latent heat, can be collected using the heat exchanger. In embodiments, the collected energy can be used to preheat compressed air that can be used to spin a turbine.

The compressed air or liquid air can be coupled to an expander 530. The expander can be coupled to a turbine 534, where the turbine can be spun by the release of the compressed air. As compressed air expands or is released, the compressed air cools. The result of the cooling air can be to precipitate out any moisture that can be contained within the compressed air. The precipitating moisture can cause the turbine to freeze or ice up due to an accumulation of frost within the turbine. To prevent icing up of the turbine, heat collected by the heat exchanger can be injected 532 into the expander 530. The turbine can be coupled to or include a generator (not shown). The generator can produce output power 540. The output power can be used to meet increased power load requirements. The output power can be generated from the stored energy, where the stored energy can be generated by the intermittent power sources. The output power can be generated from the stored energy after a period of time that is based on a short-term basis or a long-term basis.

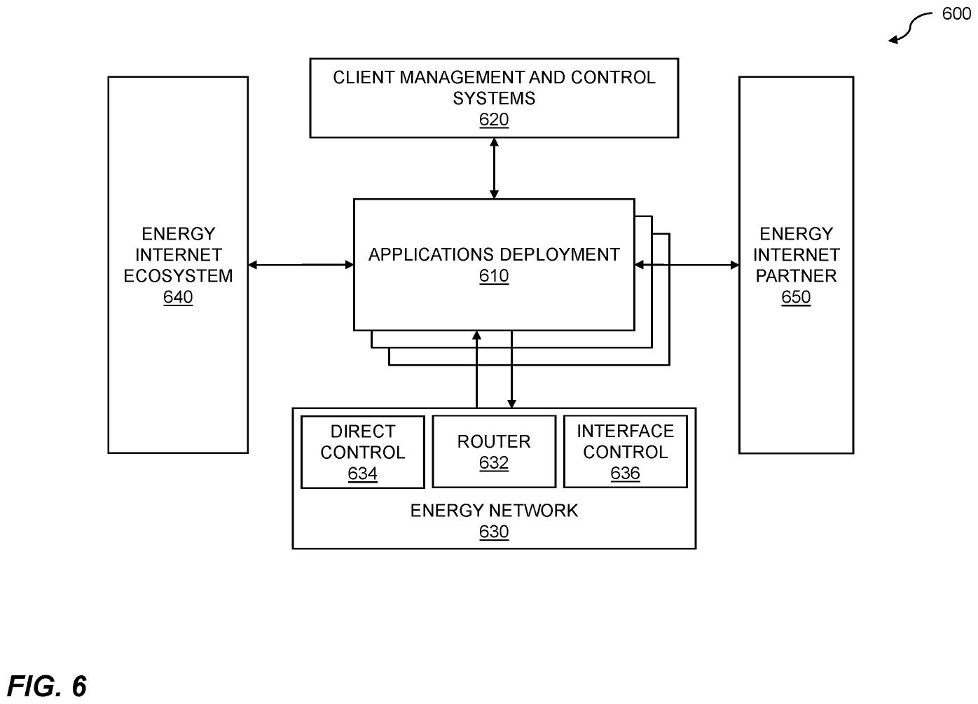

FIG. 6 illustrates an energy internet block diagram. An energy internet 600 enables energy management using an electronic flywheel. A plurality of AC electrical power sources is obtained, where the sources are both parallel to and independent from each other. At least one of the plurality of AC sources comprises a motor-generator. The plurality of AC sources is coupled to an AC power grid using an electronic flywheel module, where the electronic flywheel module enables both energy sourcing and energy sinking into a DC energy storage subsystem. The DC energy storage subsystem comprises batteries or capacitors. Frequencies of one or more of the plurality of AC power sources are synchronized using the electronic flywheel module, where the synchronizing is based on an operating frequency of the AC power grid. The synchronizing includes adjusting the speed of the motor-generator. A mix of energy flow is regulated between the plurality of AC sources and the DC energy storage subsystem. AC power is provided to the AC power grid, where the AC power is conditioned through the synchronizing and the regulating. The power flow that is conditioned includes mitigation of voltage harmonics, voltage droop, current surge, loss of power, leakage, and phase balance. The energy internet can include applications deployment 610. The applications deployment for an energy internet can include a cluster, where the cluster includes one or more application programming interfaces (APIs) for handling data, policies, communications, control, and so on. The data can include energy storage, pump-turbine storage, energy from water power, grid energy, etc. The data can include information from energy generators, partners, and so on. The data can further include third-party data from parties including energy consumers such as oil rigs; solar, wind, tidal, or wave-action farms; datacenters; and the like.

Applications deployment can communicate with client management and control systems 620. The management can include infrastructure management, microgrid management, operating management, automated controls, and so on. The management can include management of client legacy equipment. The communicating between applications deployment and client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 630. The energy network can include one or more energy routers 632, direct control 634, interface control 636, and so on. An energy router 630 can include digital switches for routing energy from a point of energy generation to a point of energy load. An energy router can be coupled to one or more direct control 634 sensors for detecting switch status, point of source status, point of load status, etc. An energy router can be coupled to direct control actuators for steering energy from one or more points of source to a given point of load. An energy router can be further connected to one or more third-party interface control 636 sensors and third-party interface control actuators. The interface control sensors and interface control actuators can be coupled to equipment such as legacy equipment which may not be directly controllable.

The energy internet (EI) can include an energy internet ecosystem 640. The energy internet ecosystem 640 can include a set of services comprised of an energy internet catalog, software, applications, machine-learning algorithms, planning and optimization applications, software-defined machine programming, and so on. The energy internet ecosystem 640 can include entities which own and operate elements of the energy internet. The energy internet ecosystem 640 can include policies governing control of access and information about energy internet elements. Energy internet elements may themselves be compositions of energy internets, energy internet elements, the processes and mechanisms, both physical and logical, implemented by those elements, and so on. The energy internet connections composing the energy internet may be organized as any network topology such as a star, peer-to-peer, or mesh and may exist as one or more energy internet clouds of information-processing and other energy-internet elements. The energy internet organization can vary as needed to provide a balance between economy, reliability, and resiliency. Energy internet services can similarly be variously organized such that a service (e.g. an energy internet catalog) is embodied in a distributed application that operates across changes in the connections from which the energy internet is comprised. Information communicated over the energy internet can be used to provide models for applications governing the operations of the energy internet and its ecosystem as a whole and for the dynamic instantiation of software-defined machines composed through connections of energy internet elements.

The energy internet can include an energy internet cloud, an energy internet catalog, and so on. The energy internet (EI) cloud can include an energy internet secure application programming interface (API) through which the EI cloud can be accessed. The EI ecosystem can include third-party applications such as an application or app store, application development and test techniques, collaboration, assistance, security, and so on. The EI cloud can include an EI catalog. The EI catalog can include technology models, plant and equipment information, sensor and actuator data, operation patterns, etc. The EI catalog, along with other elements of the energy internet, can enable or prevent access to their contents and functions according to security policies that govern them. The EI cloud can include tools or “as a service” applications such as learning and training, simulation, remote operation, and the like. The energy internet can include energy internet partners 650. The EI partners can provide a variety of support techniques including remote management, cloud support, cloud applications, learning, and so on.

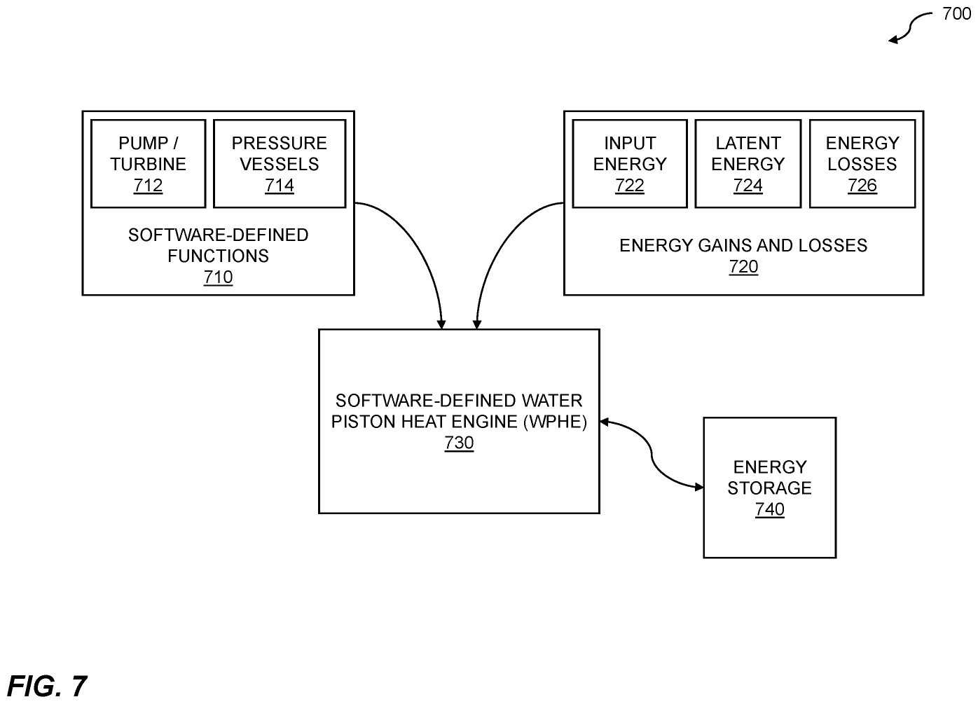

FIG. 7 shows a software-defined water piston heat engine (WPHE). Energy can be generated, stored, recovered, transformed, delivered, and so on, to meet energy load requirements. Energy storage can be accomplished when a surplus of energy is being generated from energy sources including renewable energy sources such as wind, solar, tidal, wave-action, and so on. The energy can be stored on a short-term basis such as a length of time substantially less than one week, or on a long-term basis such as a length of time substantially more than one day. The energy transforming and providing can be used for energy management using an electronic flywheel. A plurality of AC electrical power sources is obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. The DC energy storage subsystem can include batteries or capacitors. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, wherein the AC power is conditioned through the synchronizing and the regulating.

A software-defined water piston heat engine system 700 is shown. The water piston heat engine includes one or more software-defined functions 710. The one or more software-defined functions can configure or control energy management system components, subsystem components, etc. The software-defined functions can include a pump-turbine function 712. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 714. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The water piston heat engine can include energy gains and losses 720. Energy gains can include input energy 722. The input energy can include energy that can be input for storage. The input energy can include grid energy, locally generated energy, renewable energy, and so on. Energy gains can include latent energy 724. Latent energy can be captured from phase changes such as a change from a gas to a liquid, from a liquid to a solid, and so on. The latent energy can be stored. The water piston heat engine can include energy losses 726. Energy losses can include pressure losses from pressurized vessels, temperature losses, electrical charge leakage, and so on. The system 700 includes a software-defined water piston heat engine (WPHE) 730. The software-defined WPHE can use software to configure the software defined functions, to control energy storage and recovery, and so on. The WPHE can include an energy management system that can be operated by an energy management control system. The energy management control system can add or remove energy generation subsystems or energy storage subsystems as needed. The energy management control system can support hot-swapping of one or more subsystems. Hot-swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system, such as the fluid-based energy management system, includes energy storage 740 for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time bases can be used. In other embodiments, the long-term basis can be an integer number of weeks, months, seasons, or years, wherein the integer number of weeks, months, seasons, or years comprises a length of time substantially more than one day.

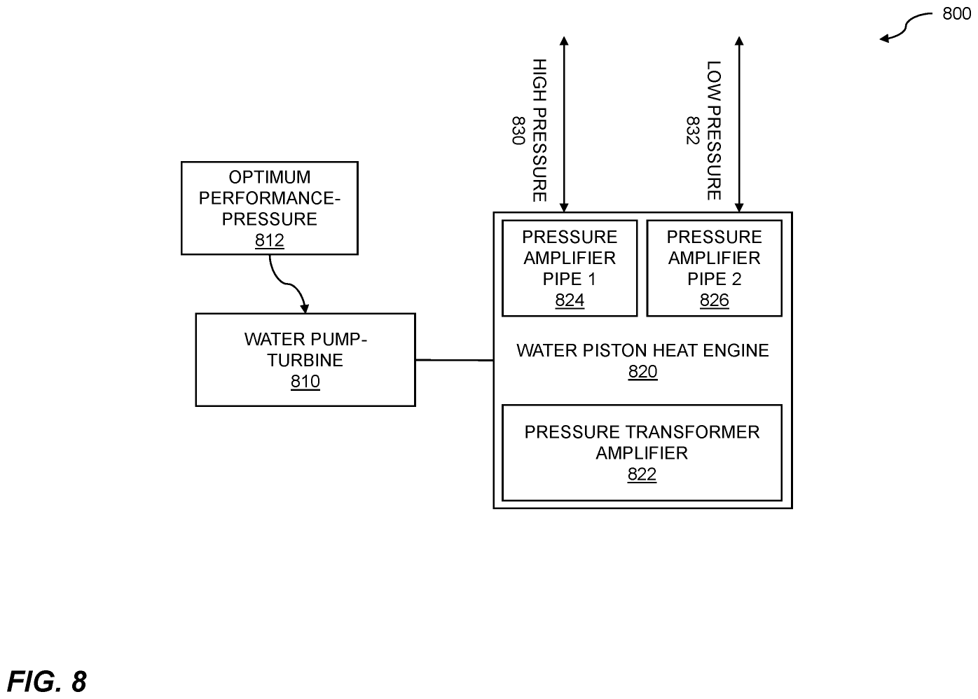

FIG. 8 illustrates fluid-based pump energy input/output. Input energy can be obtained from a variety of AC electrical energy sources, where the energy sources can include grid energy, renewable energy, and so on. The input energy can be stored based on gaseous energy transfer, liquid energy transfer, electrical energy storage, chemical energy storage, and so on. Stored energy can be provided to meet energy demands. Energy that was stored based on gaseous energy transfer, liquid energy transfer, electrical energy storage, chemical energy storage, and so on, can be transformed. The transformation of the stored energy can include transforming energy such as thermal or chemical energy into another form of energy such as mechanical energy. The mechanical energy can be used to spin a turbine or other component to transform the mechanical energy into a further form of energy such as electrical energy. The stored energy can be transformed from any of a variety of storage formats using a pump-turbine subsystem, where the pump-turbine subsystem can be operated by an energy management system. The management of storing energy and outputting energy can be performed by an energy management system, where the energy management system can be based on using an electronic flywheel. The energy management system can be operated by an energy management control system. The energy management control system can control obtaining a plurality of AC electrical power sources, coupling the plurality of AC sources to an AC power grid using an electronic flywheel module, synchronizing frequencies of one or more of the plurality of AC power sources using the electronic flywheel module, regulating a mix of energy flow between the plurality of AC sources and the DC energy storage subsystem, and providing AC power to the AC power grid, wherein the AC power is conditioned through the synchronizing and the regulating. An AC source from the plurality of AC sources can include a pump-generator.

Fluid-based pump energy input/output 800 can include a water pump-turbine 810. While a water pump-turbine is shown and described, the pump-turbine can include a motor-generator. The pump of the pump-turbine component can include a pump for pumping gases, a pump for two phases such as gas and liquid, a pump for a slurry, and so on. The water pump can be integral to a pump-turbine component, a standalone pump, etc. In embodiments, the water pump-turbine can be operated at an optimum performance-pressure 812. The water pump can provide input energy to a water piston heat engine 820 (WPHE). A WPHE, or a liquid piston heat engine, can be used to convert the liquid or gas provided by the pump to a storage format. The WPHE can transform the input energy to a variety of energy storage formats. In embodiments, the WPHE sends energy to a pressure transformer amplifier 822. As described throughout, the pressure transformer amplifier can include one or more pressure amplifier pipes. The one or more pressure amplifier pipes can include a pressure amplifier pipe 1 824, a pressure amplifier pipe 2 826, and so on. While two pressure amplifier pipes are shown, other numbers of pressure amplifier pipes can be used. The pressure amplifier pipes can provide a high pressure 830 amplifier pipe or a low pressure amplifier pipe 832. In embodiments, the WPHE can send energy to storage via liquid energy transfer, where the liquid sources can include liquefied gases such as liquid air, ice, an ice slurry, etc. Gas can also be used for storing energy. The WPHE can send energy to gaseous storage formats. The gaseous storage formats can include a vacuum, air, a gas, and so on. The gas can include a specialized gas such as Freon™. The WPHE can transform the energy that can be received from the water pump-turbine to energy for storage in a pressure amplifier, to liquid energy transfer, or to gaseous energy. The transfer can be accomplished using the mechanical energy of the water pump.

The water pump-turbine can be used for providing energy. In embodiments, the providing includes providing AC power to the AC power grid. The AC power grid can include a utility transmission grid, a wide-scale distribution grid, or a local microgrid. Energy that was stored based on gaseous energy transfer, liquid energy transfer, electrical energy storage, chemical energy storage, and so on, can be transformed. The transformation of the stored energy can include transforming energy such as thermal or chemical energy into another form of energy such as mechanical energy. In embodiments, the transformation of stored energy can include transforming energy from pressure amplification, where the pressure amplification can be based on pressure amplifier pipes. The mechanical energy can be used to spin a turbine or other component to transform the mechanical energy into a further form of energy such as electrical energy. The stored energy can be transformed from any of a variety of storage formats using a pump-turbine subsystem, where the pump-turbine subsystem can be operated by an energy management system.

The water pump-turbine can receive stored energy from the water piston heat engine 820 (WPHE). A WPHE, or a liquid piston heat engine, can be used to convert thermal or chemical energy to mechanical energy. The WPHE can receive energy from a variety of energy sources. In embodiments, the WPHE receives energy from the pressure transformer amplifier 822. As described throughout, the pressure transformer amplifier can include one or more pressure amplifier pipes. The pressure amplifier pipes can provide high pressure 830 or low pressure 832. The WPHE can receive energy from liquid sources. In embodiments, the WPHE receives energy from liquid energy transfer. Liquid energy transfer can be accomplished using a heat exchanger, a heat injector, a chiller, and so on. Liquid sources can include liquefied gases such as liquid air. The WPHE can receive energy from gaseous sources. The gaseous sources can include a vacuum, air, a gas, and so on. The gas can include a specialized gas such as Freon™. One or more gases can provide energy through gaseous energy transfer. The WPHE can transform the energy that can be recovered from the pressure amplifier, from liquid energy transfer, or from gaseous energy transfer into mechanical energy. The mechanical energy can be used to spin the turbine, where the spinning turbine can be used to generate electrical energy.

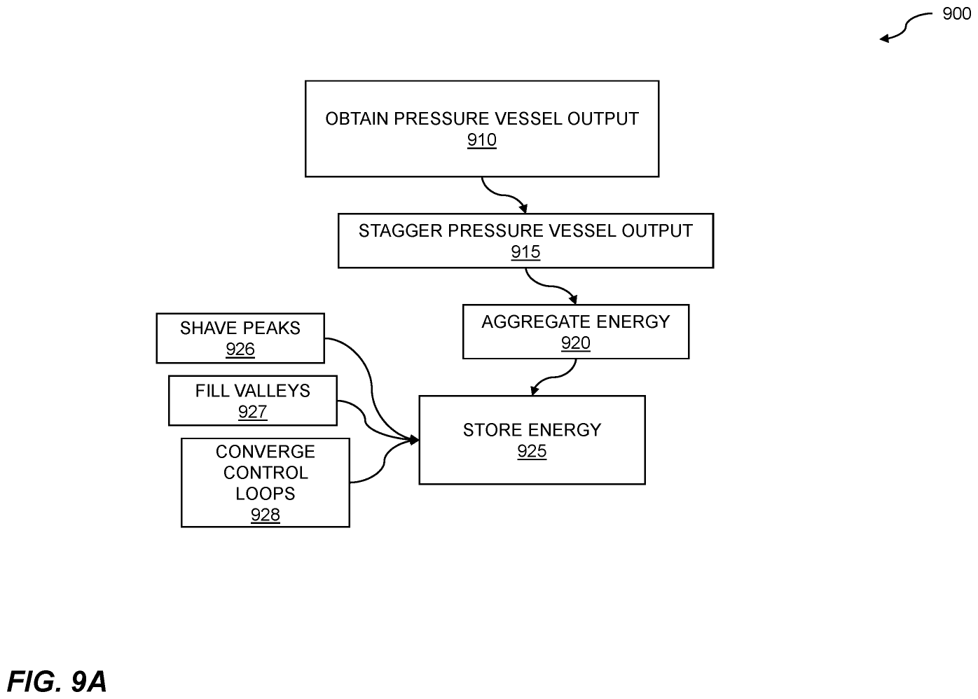

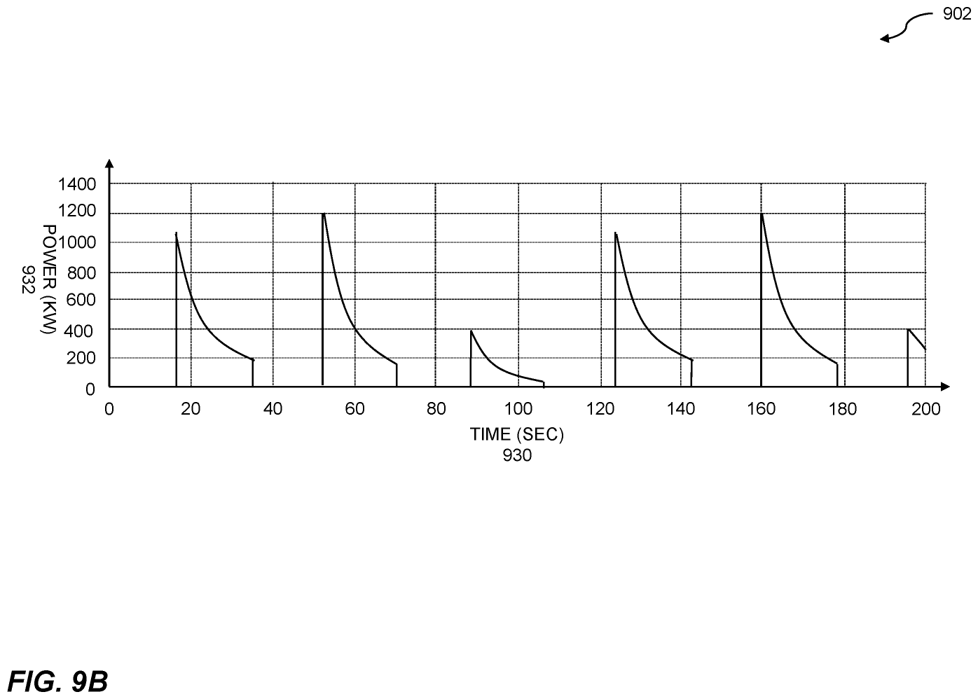

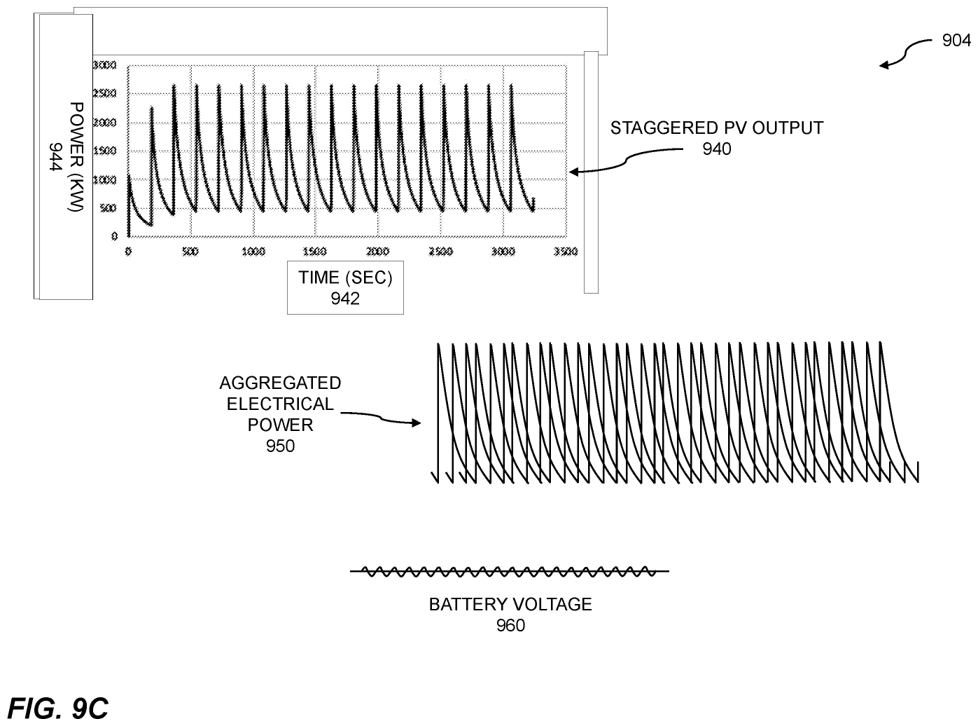

FIG. 9A is a flow diagram for multi-layered system balancing. Energy, including energy from renewable sources such as solar, wind, tidal, etc., can be collected and stored while the sources are generating energy or when an energy surplus exists. Various energy storage techniques such as storing electrical energy in batteries or capacitors, thermal energy in ice or steam, potential energy based on hydraulic head, compressed air, or compressed gas, and so on can be used. A given energy storage technique may be able to store and provide more or less energy in comparison to other storage techniques. Further, the given energy storage technique may not provide a consistent amount of energy. By layering a plurality of energy storage techniques, energy can be provided at a consistent voltage and frequency, where the voltage and frequency are appropriate for coupling to a local grid or other grid. Multi-layered system balancing includes energy management using an electronic flywheel. A plurality of AC electrical energy sources is obtained, where the sources are both parallel to and independent from each other. The plurality of AC sources is coupled to an AC power grid using an electronic flywheel module, where the electronic flywheel module enables both energy sourcing and energy sinking into a DC energy storage subsystem. Frequencies of one or more of the plurality of AC power sources are synchronized using the electronic flywheel module, where the synchronizing is based on an operating frequency of the AC power grid. A mix of energy flow is regulated between the plurality of AC sources and the DC energy storage subsystem. AC power is provided to the AC power grid, wherein the AC power is conditioned through the synchronizing and the regulating.

The flow 900 includes obtaining pressure vessel output 910. The pressure vessel can include an above ground vessel, a below ground vessel, an unused oil well, a cavern, an underwater vessel, and so on. The pressure vessel can contain steam, compressed gas or air, etc. In embodiments, an underwater vessel can be pressurized by the weight of the water above the vessel. The pressure vessel can comprise a column of liquid such as water. The output of the pressure vessel can vary over time. For example, pressure output obtained from a column of water or a decompressing gas vessel can diminish as the column of water or the pressure within the vessel drops. Pressure vessel output can further be time dependent based on how the vessel is operated. Operation of the pressure vessel can include compression, heat removal, decompression, heat injection, fluid injection to make steam, and so on. As a result, the pressure vessel output can vary.

The flow 900 includes staggering pressure vessel output 915. Staggering pressure vessel output can include delaying in time outputs from a plurality of pressure vessels. Note that the output from a pressure vessel can require an amount of time to obtain a maximum output, a steady state output, etc. The flow 900 includes aggregating energy 920. Aggregating energy can include aggregating the energy outputs from the plurality of pressure vessels. The outputs from the pressure vessels can be based on compressed gas or air outputs, steam, hydraulic head, etc. The flow 900 includes storing energy 925. In embodiments, the energy that is stored can include electrical energy, where the electrical energy can be stored with batteries, capacitors, and so on. The batteries can include sealed lead acid batteries, lithium ion batteries, etc. The capacitors can include supercapacitors. The flow 900 includes shaving peaks 926. The shaving peaks can include collecting unused available power when supply exceeds demand. The flow 900 includes filling valleys 927. The valleys can result when power demand exceeds supply. The flow 900 includes converging control loops 928. The control loops can include control loops for controlling one or more pressure vessels. The converging control loops of a plurality of pressure vessels can enable stabilization of the energy that is stored.

FIG. 9B shows pressure vessel level output waveforms. A pressure vessel can include a pressure vessel associated with a water pressure heat engine (WPHE). The WPHE can comprise a variety of components such as a pump for moving a liquid such as water; a pressure vessel which can contain a gas such as air; a heat exchanger for removing or inserting heat; a liquid injector for providing a cooling mist or for generating steam, and so on. The pressure vessel can include a pump such as a pump associated with a pump-turbine, which can be used to move a fluid such as water. The water can be pumped into a vessel that contains a gas such as nitrogen, air, and so on. Pressurized air or gas that results from pumping water into the pressure vessel can be stored, as can steam that can be generated. The WPHE can operate in a variety of modes including energy storage, energy generation, waste heat recovering, and so on. An output from a pressure vessel can vary based on the mode of operation of the WPHE. Output waveforms based on the operation of the pressure vessel of a WPHE are shown 902. The waveforms vary over time 930, and represent a power output 932. Note that the waveforms show that the power provided can include zero kilowatts. In embodiments, a plurality of pressure vessels can be used to provide additional power when the power output from a single pressure vessel is insufficient.

FIG. 9C shows multi-layered system balancing waveforms. The power output from a given pressure vessel can vary. The power output from the pressure vessel can spike to a maximum value and can decay over time. Further, the power output of the vessel can be zero. By obtaining power from a plurality of pressure vessels, the power output can be balanced based on a multi-layered system 904. A graph showing a staggered pressure output is shown 940. In the graph, power output 944 is plotted with respect to time 942. The staggered pressure output can be obtained by staggering the outputs from a plurality of pressure vessels. In embodiments, the staggered pressure output can be obtained from nine pressure vessels. Recall that the energy stored by the WPHE as steam, a compressed gas, hydraulic head, and so on, can be converted by the WPHE to electrical energy by spinning a pump-turbine, a turbine, etc. The electrical power converted by a plurality of WPHEs can be aggregated as shown in graph 950. The aggregating of the electrical energy can be controlled to obtain a desired peak power value, a root-mean-square (RMS) power value, and the like. The electrical energy can be controlled to obtain a desired frequency. AC power, which can include aggregated electrical power, can be converted to DC power. The DC power can include a battery voltage as shown in plot 960. One or more batteries can be used to store the DC power. The desired battery voltage can be obtained by peak shaving, valley filling, converging control loops, and so on, as discussed previously.

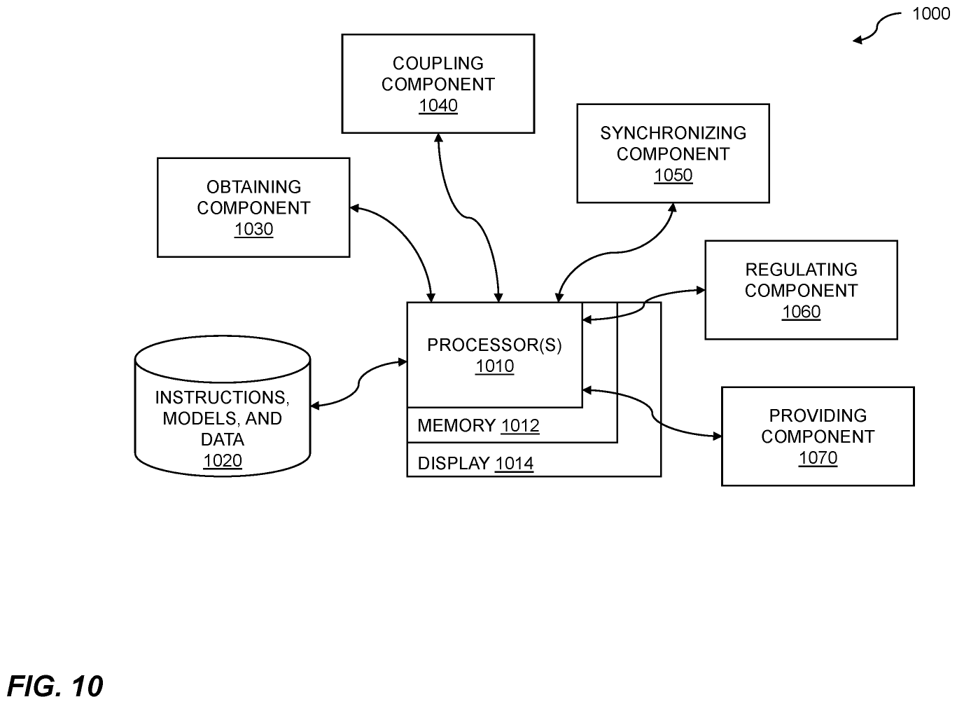

FIG. 10 is a system diagram for energy management. The energy management uses an electronic flywheel. A plurality of AC electrical energy sources is obtained. The AC electrical energy sources include conventional energy sources such as coal, natural gas, or nuclear energy fuels; renewable fuels such as biogas or biofuels; renewable energy sources such as solar, wind, geothermal, hydro, tidal, or wave action, etc. At least one of the plurality of AC sources includes a motor-generator. The sources are both parallel to and independent from each other. The plurality of AC sources is coupled to an AC power grid using an electronic flywheel module. The AC power grid comprises a utility transmission grid, a wide-scale distribution grid, or a local microgrid. The electronic flywheel module enables both energy sourcing and energy sinking into a DC energy storage subsystem. The DC energy storage subsystem comprises batteries or capacitors. Frequencies of one or more of the plurality of AC power sources are synchronized using the electronic flywheel module. The synchronizing is based on an operating frequency of the AC power grid. The operating frequency can include 50 Hz, 60 Hz, etc. The synchronizing includes adjusting the speed of the motor-generator. A mix of energy flow is regulated between the plurality of AC sources and the DC energy storage subsystem. AC power is provided to the AC power grid. The AC power is conditioned through the synchronizing and the regulating.

The system 1000 can include one or more processors 1010 and a memory 1012 which stores instructions. The memory 1012 is coupled to the one or more processors 1010, wherein the one or more processors 1010 can execute instructions stored in the memory 1012. The memory 1012 can be used for storing instructions; for storing databases of energy subsystems, modules, or peers for system support; and the like. Information regarding energy management using an electronic flywheel can be shown on a display 1014 connected to the one or more processors 1010. The display can comprise a television monitor, a projector, a computer monitor (including a laptop screen, a tablet screen, a netbook screen, and the like), a smartphone display, a mobile device, or another electronic display. The system 1000 includes instructions, models, and data 1020. The data can include information on energy sources, energy conversion requirements, metadata about energy, and the like. In embodiments, the instructions, models, and data 1020 are stored in a networked database, where the networked database can be a local database, a remote database, a distributed database, and so on. The instructions, models, and data 1020 can include instructions for obtaining operating data from a plurality of AC electrical power sources, one or more synchronizing goals for AC power source frequencies or regulating goals for a mix of energy flows, instructions for analyzing operating data, instructions for controlling the operation of energy modules, etc.

The system 1000 includes an obtaining component 1030. The obtaining component 1030 can obtain a plurality of AC electrical power sources. The AC electrical power sources can include components of an energy management system using an electronic flywheel. The AC electrical energy sources can include grid energy sources, renewable energy sources, local energy sources, and so on. In embodiments, at least one of the plurality of AC sources comprises a motor-generator. The sources can be both parallel to and independent from each other. In other embodiments, the motor-generator can include a pump-turbine. The AC electrical energy sources can include AC energy sources comprising various voltages or frequencies. The system 1000 includes a coupling component 1040. The coupling component 1040 can couple the plurality of AC sources to an AC power grid using an electronic flywheel module. The electronic flywheel can correct for deleterious qualities of energy from AC sources, where the deleterious qualities can include voltage harmonics, voltage droop, current surge, loss of power, leakage, phase balances, etc. The electronic flywheel module enables both energy sourcing and energy sinking into a DC energy storage subsystem. In embodiments, the DC energy storage subsystem can include batteries and capacitors.

The system 1000 includes a synchronizing component 1050. The synchronizing component 1050 can synchronize frequencies of one or more of the plurality of AC power sources using the electronic flywheel module. The synchronizing is based on an operating frequency of the AC power grid. The AC power sources can include frequencies based on standard AC power source frequencies such as 50 Hz, 60 Hz, and so on. The AC power sources can be in synchronization or out of synchronization based on phase differences between or among the AC power sources. In embodiments, the synchronizing can include adjusting the speed of the motor-generator. The system 1000 includes a regulating component 1060. The regulating component 1060 can regulate a mix of energy flow between the plurality of AC sources and the DC energy storage subsystem. The regulating can include shaving or sinking an amount of energy excess to energy load requirements from the AC energy sources and can store the shaved energy in the DC energy storage subsystem. The regulating can include sourcing an amount of energy to meet energy load requirements from the DC energy storage subsystem. The system 1000 includes a providing component 1070. The providing component can provide AC power to the AC power grid. The AC power is conditioned through the synchronizing and the regulating. In embodiments, the providing can condition power flow within the AC power grid. The AC power grid can include an on-site power grid, a town-wide grid, a state-wide or regional grid, and the like. In embodiments, the AC power grid can include a utility transmission grid, a wide-scale distribution grid, or a local microgrid. The conditioning can be accomplished using the electronic flywheel. In embodiments, the power flow that is conditioned can include mitigation of voltage harmonics, voltage droop, current surge, loss of power, leakage, and phase balance.

Disclosed embodiments can include a computer program product embodied in a non-transitory computer readable medium for energy management, the computer program product comprising code which causes one or more processors to perform operations of: obtaining a plurality of AC electrical power sources, wherein the sources are both parallel to and independent from each other; coupling the plurality of AC sources to an AC power grid using an electronic flywheel module, wherein the electronic flywheel module enables both energy sourcing and energy sinking into a DC energy storage subsystem; synchronizing frequencies of one or more of the plurality of AC power sources using the electronic flywheel module, wherein the synchronizing is based on an operating frequency of the AC power grid; regulating a mix of energy flow between the plurality of AC sources and the DC energy storage subsystem; and providing AC power to the AC power grid, wherein the AC power is conditioned through the synchronizing and the regulating.

Disclosed embodiments can include a computer system for energy management comprising: a memory which stores instructions; one or more processors coupled to the memory wherein the one or more processors, when executing the instructions which are stored, are configured to: obtain a plurality of AC electrical power sources, wherein the sources are both parallel to and independent from each other; couple the plurality of AC sources to an AC power grid using an electronic flywheel module, wherein the electronic flywheel module enables both energy sourcing and energy sinking into a DC energy storage subsystem; synchronize frequencies of one or more of the plurality of AC power sources using the electronic flywheel module, wherein the synchronizing is based on an operating frequency of the AC power grid; regulate a mix of energy flow between the plurality of AC sources and the DC energy storage subsystem; and provide AC power to the AC power grid, wherein the AC power is conditioned through the synchronizing and the regulating.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for energy management comprising:
obtaining a plurality of AC electrical power sources, wherein the sources are both parallel to and independent from each other;
coupling the plurality of AC sources to an AC power grid using an electronic flywheel module, wherein the electronic flywheel module enables both energy sourcing and energy sinking into a DC energy storage subsystem;
synchronizing frequencies of one or more of the plurality of AC power sources using the electronic flywheel module, wherein the synchronizing is based on an operating frequency of the AC power grid;
regulating a mix of energy flow between the plurality of AC sources and the DC energy storage subsystem; and
providing AC power to the AC power grid, wherein the AC power is conditioned through the synchronizing and the regulating.

2. The method of claim 1 wherein at least one of the plurality of AC sources comprises a motor-generator.

3. The method of claim 2 wherein the synchronizing includes adjusting the speed of the motor-generator.

4. The method of claim 2 wherein the motor-generator comprises a pump-turbine.

5. The method of claim 4 further comprising coupling a water piston heat engine using the pump-turbine.

6. The method of claim 5 wherein the water piston heat engine enables fluid energy storage.

7. The method of claim 5 wherein the water piston heat engine is operated by an energy management control system.

8. The method of claim 7 wherein the energy management control system controls transfer of energy within the pump-turbine, the water piston heat engine, and the electronic flywheel module.

9. The method of claim 2 wherein the providing enables surge power regulation to the motor-generator.

10. The method of claim 1 wherein the DC energy storage subsystem includes batteries and capacitors.

11. The method of claim 10 wherein the capacitors include supercapacitors.

12. The method of claim 10 wherein the DC energy storage system sinks excess energy from the plurality of AC sources through the electronic flywheel module.

13. The method of claim 12 wherein the excess energy is used to charge the batteries of the DC energy storage system.

14. The method of claim 12 wherein the excess energy is used to charge the capacitors of the DC energy storage system.

15. The method of claim 10 wherein the DC energy storage system sources stored energy to the AC power grid through the electronic flywheel module.

16. The method of claim 15 wherein the stored energy is provided from the batteries or the capacitors of the DC energy storage system.

17. The method of claim 1 wherein the providing conditions power flow within the AC power grid.

18. The method of claim 17 wherein the power flow that is conditioned includes mitigation of voltage harmonics, voltage droop, current surge, loss of power, leakage, and phase balance.

19. The method of claim 1 wherein the AC power grid comprises a utility transmission grid, a wide-scale distribution grid, or a local microgrid.

20. A computer program product embodied in a non-transitory computer readable medium for energy management, the computer program product comprising code which causes one or more processors to perform operations of:
obtaining a plurality of AC electrical power sources, wherein the sources are both parallel to and independent from each other;
coupling the plurality of AC sources to an AC power grid using an electronic flywheel module, wherein the electronic flywheel module enables both energy sourcing and energy sinking into a DC energy storage subsystem;
synchronizing frequencies of one or more of the plurality of AC power sources using the electronic flywheel module, wherein the synchronizing is based on an operating frequency of the AC power grid;
regulating a mix of energy flow between the plurality of AC sources and the DC energy storage subsystem; and
providing AC power to the AC power grid, wherein the AC power is conditioned through the synchronizing and the regulating.

21. A computer system for energy management comprising:
a memory which stores instructions;
one or more processors coupled to the memory wherein the one or more processors, when executing the instructions which are stored, are configured to:
obtain a plurality of AC electrical power sources, wherein the sources are both parallel to and independent from each other;
couple the plurality of AC sources to an AC power grid using an electronic flywheel module, wherein the electronic flywheel module enables both energy sourcing and energy sinking into a DC energy storage subsystem;
synchronize frequencies of one or more of the plurality of AC power sources using the electronic flywheel module, wherein the synchronizing is based on an operating frequency of the AC power grid;
regulate a mix of energy flow between the plurality of AC sources and the DC energy storage subsystem; and
provide AC power to the AC power grid, wherein the AC power is conditioned through the synchronizing and the regulating.
